(19) United States
(12) Patent Application Publication
(10) Pub. No.: US 2017/0331265 A1
(43) Pub. Date: Nov. 16, 2017

(54) ELECTRICAL OUTLET COVER

(71) Applicant: Brian Evilsizer, Westlake, OH (US)

(72) Inventor: Brian Evilsizer, Westlake, OH (US)

(21) Appl. No.: 15/596,067

(22) Filed: May 16, 2017

Related U.S. Application Data
(60) Provisional application No. 62/337,056, filed on May 16, 2016.

(51) Int. Cl. H02G 3/08; H02G 3/14

(52) U.S. Cl. CPC H02G 3/081; H02G 3/14

(57) ABSTRACT

An outlet cover that includes a substantially continuous face having no apertures extending therethrough, except for openings that correspond in size, shape, number, and arrangement to contact openings in an associated electrical outlet that is to be covered by the outlet cover. The outlet cover substantially covers an associated electrical outlet, thereby inhibiting the color of the electrical outlet from being seen. However, the outlet cover does not cover the contact openings of the associated electrical outlet since the openings in the outlet cover align with, and therefore allow access to the contact openings when the outlet cover is properly arranged to cover the electrical outlet.

### CROSS-REFERENCE TO RELATED APPLICATIONS

This application claims priority to U.S. Provisional Application 62/337,056, filed May 16, 2016, which is incorporated herein by reference.

### FIELD

The present subject matter relates to a cover plate or wall plate for an electrical outlet.

### BACKGROUND

Typical outlet systems include an electrical outlet and a wall plate for partially covering the electrical outlet. Electrical outlets typically include one or more receptacles, each including several contact openings for receiving prongs of an associated electrical plug of an electrical device. A receptacle is ordinarily made of plastic, and may come in a variety of colors including white, almond, brown, grey, or black, for example. Electrical outlets are typically arranged in a recess or opening in a wall of a building or other structure, such that the receptacle is flush, or nearly so, to the wall and is accessible to engage with an electrical plug.

Wall plates (also referred to herein as “outlet covers” or “cover plates”) are ordinarily arranged over the electrical outlet so as to at least partially cover the outlet and the opening in the wall in which the outlet is arranged, thereby providing a finished look to the outlet system. Typically outlet covers have one or more openings in their face that allow the entire receptacle to protrude therethrough so that the receptacle is exposed and visible, and so it is accessible for mating with an associated electrical plug of an electrical device. Often and for aesthetic purposes, the wall plate and exposed receptacle have the same color.

In certain circumstances, it may be aesthetically desirable to change the color of the existing outlet system, for example from almond to white. In these circumstances, since the receptacle protrudes through the outlet cover and is visible, it becomes necessary in these situations to replace both the electrical outlet and the outlet cover. While outlet covers are relatively inexpensive and easy to change, electrical outlets are relatively more expensive and take longer to change, and often require professional installation. Therefore, the replacement of both leads to undesirable expenditures and time commitments. Accordingly, there is a need for an improved outlet system.

### SUMMARY

The difficulties and drawbacks associated with previously known electrical outlet covers, means, and strategies are addressed in the present outlet cover, and related combinations.

The present subject matter relates to outlet covers that include a substantially continuous face having no apertures extending therethrough, except for openings that correspond in size, shape, number, and arrangement to contact openings in an associated electrical outlet that is to be covered by the outlet cover, and for an optional aperture used to mount the outlet cover relative to the electrical outlet. When properly arranged relative to the associated electrical outlet, such that the openings are aligned with the contact openings of the electrical outlet, the outlet cover operates to hide the colored receptacles of an associated electrical outlet from view by completely or substantially covering the receptacles. However, the outlet cover does not cover the contact openings of the electrical outlet since the openings in the outlet cover align with, and therefore allow access to the contact openings when the outlet cover is arranged to cover the electrical outlet.

In other words, the outlet cover does not include conventional openings that allow the entire receptacle to be seen or protrude therethrough. Instead, the inventive outlet cover only includes openings that have a specific size, shape, number and arrangement that are closely associated to the size, shape, number and arrangement of contact openings in the associated electrical outlet being covered by the outlet cover. As will be appreciated, the size, shape, number and arrangement of openings in the outlet cover may also closely correspond to the number, size, shape, and arrangement of prongs of an electrical plug so that the prongs can pass through the openings in the outlet cover and electrically engage the underlying contact openings in the receptacle of the outlet.

When the outlet cover is arranged to cover over an electrical outlet, the receptacles of the outlet are covered and therefore cannot be seen from the front side of the outlet cover, while the contact openings are not covered, and are therefore accessible through the openings in the outlet cover and thereby allowing the contact openings to contact the prongs of an associated electrical plug.

Because the receptacle of the electrical outlet is substantially obscured from view by the outlet cover, the color of the receptacles cannot be seen and is therefore inconsequential to the aesthetics of the outlet system, and the color of the receptacles does not have to match the color of the outlet cover. As such, the color scheme or appearance of the entire outlet system is dependent only on the color or appearance of the outlet cover, rather than also being dependent on the color of the receptacle, as is conventional. The outlet cover thus allows the color scheme or appearance of an outlet system to be easily changed by simply using the inventive outlet cover, and does not require changing the color of the outlet, such as by replacement of the outlet itself, as is conventionally required.

The outlet cover may also include an attachment mechanism that allows the outlet cover to be easily and quickly arranged relative to the electrical outlet, possibly without the use of tools, for example by engaging to a conventional female threaded opening in the outlet.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

These, as well as other features, aspects, and advantages of the present subject matter, will be more completely understood and appreciated by referring to the following more detailed description of the exemplary embodiments of the present subject matter in conjunction with the accompanying drawings.

FIG. 1 is a perspective front view of an electrical outlet system including an outlet cover in accordance with the present subject matter.

FIG. 2 is a perspective back view of an outlet cover in accordance with the present subject matter.

FIG. 3 is a perspective back view of another outlet cover in accordance with the present subject matter.

FIG. 4 is a front elevation view of the alignment and relative size of openings in an outlet cover and contact openings in an electrical outlet when the outlet cover is covering the electrical outlet in accordance with the present subject matter.

### DETAILED DESCRIPTION OF THE EMBODIMENTS

The subject matter described herein provides an outlet cover that has a substantially continuous front face that substantially covers an associated electrical outlet, but includes openings that, when the outlet cover is properly arranged relative to the outlet, are aligned with, and thus do not cover the contact openings of the outlet. The outlet cover covers the receptacles of the outlet, and thus provides an easy method to establish the color or appearance of an outlet system without having to change the color or appearance of the receptacles, for example by changing the electrical outlet itself.

In several embodiments, the outlet cover presents a flat surface as its front face, having openings that closely correspond in size, shape, number and arrangement to the contact openings in the electrical outlet, and/or to the size, shape, number and arrangement of prongs on an associated electrical plug to be inserted into the electrical outlet. In an embodiment, the front face of the outlet cover has no openings except for the openings corresponding to the contact openings in the electrical outlet. These opening in the outlet cover allow prongs from an associated electrical plug to pass therethrough so that the prongs can be electrically engaged to the contact openings of the receptacle of the electrical outlet. This flat and planar front face gives the outlet cover a uniform flush surface design, and at the same time allows the outlet cover to hide the underlying receptacles so that the color of the receptacles do not contribute to the aesthetics of the outlet system. In one aspect, the front face of the outlet cover includes an additional aperture configured to allow a mounting screw or other connector to pass therethrough for arranging the outlet cover relative to the electrical outlet.

In this regard, the attachment mechanism of the outlet cover may comprise an aperture in the outlet cover for allowing a screw or other connector to pass therethrough and threadingly engage a female threaded opening in the electrical outlet. The attachment mechanism may alternatively comprise an integral snap, clip, or other friction fitting arranged on the back face of the outlet cover, for frictionally engaging a connector, or portion thereof such as a screw head, that is already engaged (e.g. threadingly engaged) to the threaded opening in the electrical outlet. The attachment mechanism may further comprise an integral fastener, push pin, or other retainer for frictionally engaging (as opposed to threadingly engaging) the threaded opening in the electrical outlet. When including an attachment mechanism arranged on the back face of the outlet cover, the front face of the outlet cover may be substantially continuous except of the openings to be aligned with the contact openings in the associated electrical outlet.

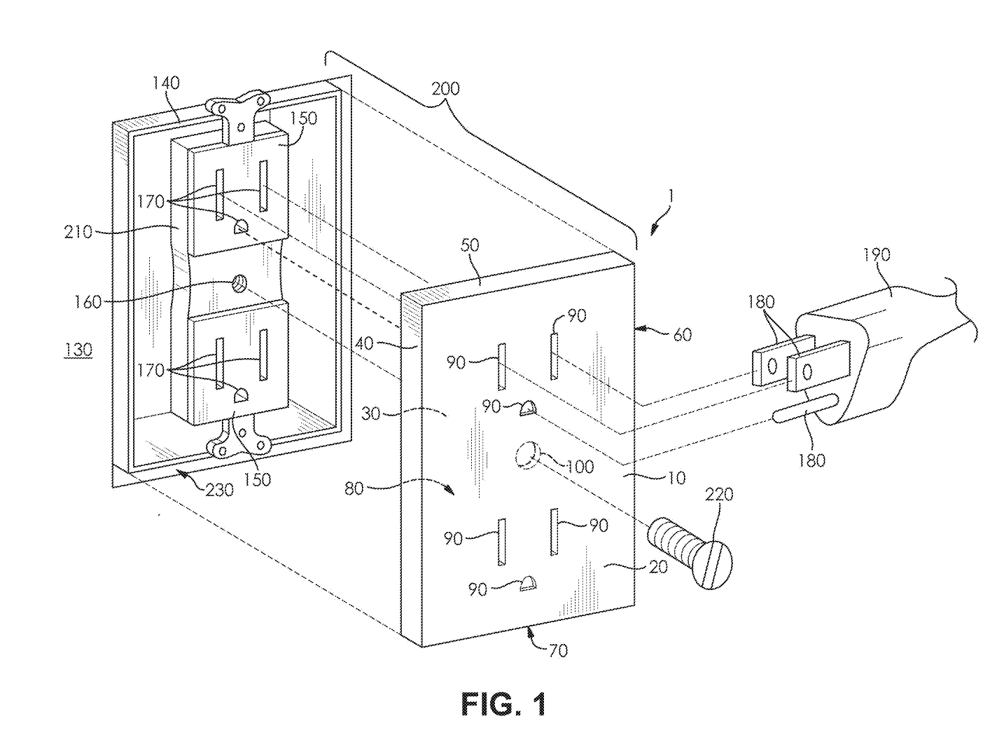

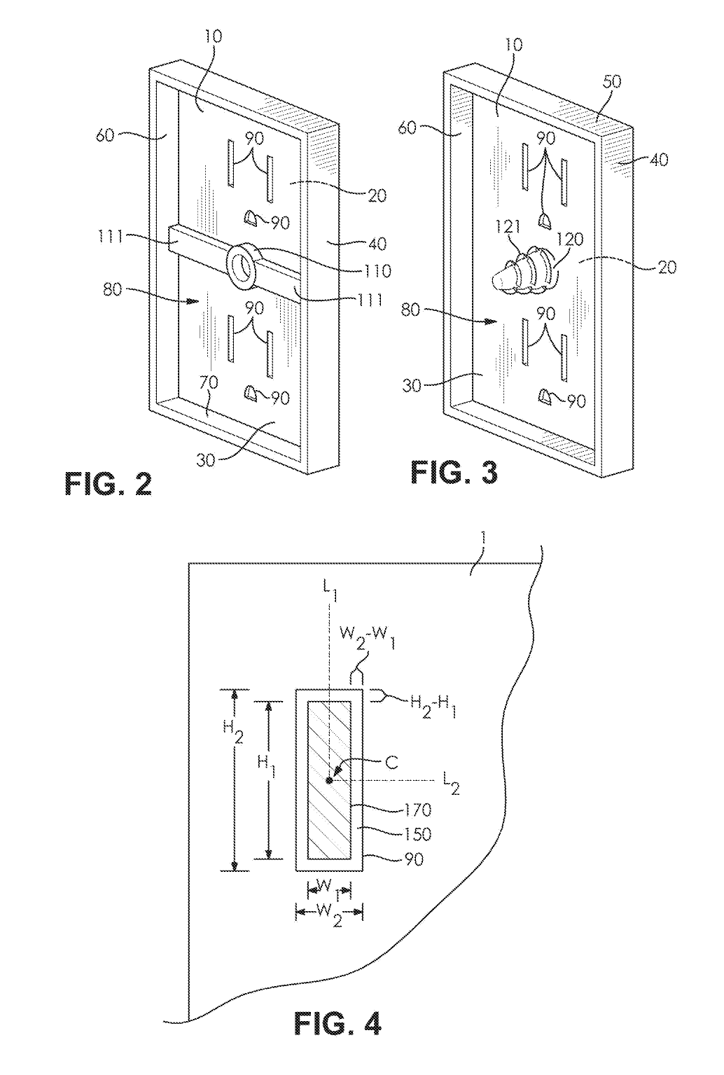

Referring now the attached figures, there is shown several example embodiments of outlet covers in accordance with the present subject matter. FIG. 1 depicts and outlet system 200 including an outlet cover 1, and FIGS. 2 and 3 depict outlet covers 1.

The outlet system 200 depicted in FIG. 1 includes an electrical outlet 210 and outlet cover 1. As depicted, the electrical outlet 210 may be arranged in a recess 230 in a wall 130, and is optionally arranged in an electrical box 140 inserted in the recess 230, although, it will be appreciated that the recess 230 and/or electrical box 140 are not necessary to complete the outlet system 200. The outlet 210 includes two receptacles 150. However, the electrical outlet 210 can include more or less receptacles as desired. Each receptacle 150 includes contact openings 170 that have a shape, size, number (e.g. three) and configuration corresponding to the prongs 180 on an associated electrical plug 190 in order to accommodate the prongs 180. In other words, the contact openings 170 are configured to contact the prongs 180 by the insertion of the prongs 180 into the contact openings, thereby providing electrical power to the prongs 180, the plug 190, and an electrical device associated with the plug 190. The contact openings 170 have a size, shape, number and arrangement that corresponds to the size, shape, number and arrangement of prongs 180 on an associated electrical plug 190 to be inserted into the electrical outlet 210.

The outlet cover 1, as depicted in FIGS. 1-3, is defined by a face plate 10 (which may be generally planar and is also referred to herein as a plate) having a front face 20, an oppositely directed back face 30, and optional side walls 40, 50, 60, 70 extending from the plate 10 in a backwards direction to define a space or hollow 80 of the outlet cover 1. The space or hollow 80 at the back of the outlet cover 1 may allow the outlet cover 1 to cover an outlet 210 that has receptacles 150 that either protrude out from (or are flush with) the wall 130 or are flush with the wall 130. In an alternative embodiment, the outlet cover 1 does not include side walls 40, 50, 60, 70 extending from the face plate 10 in a backwards direction. Instead, the outlet cover 1 may a substantially flat face plate 10 with no side walls, or the face plate may be curved or contoured to define the hollow 80.

The face plate 10 includes openings 90 extending through the thickness of the face plate 10 from the front face 20 to the back face 30. The openings 90 correspond in shape, size, number (e.g. six) and arrangement (i.e. location or position) to the shape, size, number (e.g. six) and arrangement of contact openings 170 in the two receptacles 150 of an associated electrical outlet 210. As depicted, the face plate 10 includes six openings 90, which are grouped into two sets of three, i.e. an upper set of three and a lower set of three. The six openings 90 correspond to six contact openings 170 on the electrical outlet 210, which are also grouped into two sets of three, i. e. upper and lower sets. Each set of three contact openings 170 on each of the two receptacles 150 are configured to electrically engage three prongs 180 on an associated electrical plug 190, which are inserted through the corresponding set of three openings 90 of the outlet cover 1, as depicted by the dashed lines in FIG. 1.

In other words, there is one opening 90 on the outlet cover 1 for each contact opening 170 in the associated electrical outlet 210. As depicted, the outlet cover 1 includes two sets of three openings 90. Each set of three openings 90 includes two elongated generally rectangular openings, which are generally configured to accept the hot and neutral prongs on a three-pronged plug as conventionally used in the United States, and one generally semicircular opening configured to accept the ground prong on a conventional three-pronged plug. As depicted, the openings 90 are separate and distinct from each other, are all spaced from each other by the solid portions of the face plate 10. The upper set of three in FIG. 1 corresponds to the three contact openings 170 on the upper receptacle 150, and the lower set of three corresponds to the three contact openings 170 of the lower receptacle 150.

When the outlet cover 1 is properly arranged to cover the electrical outlet 210, the outlet cover 1 covers the receptacles 150 to obscure the receptacles 150 from view, but the outlet cover 1 does not cover the contact openings 170 since it includes six openings 90 that align with the six contact openings 170 and thus allow the contact openings 170 to be accessible to prongs 180 of the electrical plug 190. As used herein, including in the appended claims, “properly aligned” or “properly arranged” means that the outlet cover 1 is arranged to cover the electrical outlet 210, such that the openings 90 are aligned with the contact openings 170, such that prongs 180 of an electrical plug 190 can pass through the openings 90 to contact and thus electrically engage the contact openings 170 as depicted in FIGS. 1 and 4 for example. As will be appreciated, more or less openings 90 can be included on the outlet cover 1 so that the number of openings 90 corresponds one-to-one with the number of contact openings is various types of electrical outlets having different configurations than that presented in FIG. 1. In one embodiment, the face plate 10 consists essentially of six openings 90, which means that the face plate 10 does not include any other openings through which electrical contact can be made between prongs 180 of an associated plug 190 and contact openings 170 of an associated electrical outlet 210.

In the embodiment depicted in FIG. 1, the outlet cover 1 may also include an aperture 100. When included, the aperture 100 extends through the thickness of the face plate 10 from the front face 20 to the back face 30, and is configured to allow the retaining screw 220 or other connector to pass through the face plate 10 as depicted in FIG. 1 by the dashed lines to engage the female threaded opening 160 in the associated electrical outlet 210 in order to removably secure/mount the outlet cover 1 to the electrical outlet 210. As will be appreciated, when the outlet cover 1 includes an aperture 100, the retaining screw 220 may have the same or similar color or appearance as the outlet cover 1 in order to present a consistent aesthetic appeal. In FIG. 1 the aperture 100 is shown in dashed lines. As will be understood, this because in other embodiments (e.g. FIGS. 2 and 3), the aperture 100 is not necessary or included, and the face plate 10 in those other embodiments can present a continuous flat surface except for the openings 90.

In another embodiment, and as shown in FIG. 2 for example, the outlet cover 1 includes a clip 110 arranged on the back face 30 of the face plate 10, for example the clip 110 may be integral with the back face 30. The clip 110 can be used to frictionally engage a connector, or portion thereof, for example by fitting over or around the head of a screw that is threaded into the threaded opening 160 of the electrical outlet 210. Such frictional engagement of the clip 110 to the head of the screw removably secures/mounts the outlet cover 1 relative to the electrical outlet 210 in a clip-on fashion. This arrangement provides uniform appearance at the front side of the outlet cover 1, since the screw is not visible from the front side of the outlet cover 1. Moreover, this arrangement simplifies mounting the outlet cover 1 to the electrical outlet 210, since the outlet cover can be mounted or removed by hand from the electrical outlet 210 without the use of tools.

In still another embodiment, and as shown in FIG. 3 for example, the outlet cover includes a fastener 120 arranged on, for example integral with, the back face 30 of the face plate 10. The fastener 120 may include flexible fins 121 or other features extending therefrom to frictionally engage the interior walls of the female threaded opening 160 in the associated electrical outlet 210 to removably secure/mount the outlet cover 1 to the electrical outlet 210. This arrangement does not require the use of a separate screw for mounting the outlet cover relative to the female threaded opening 160, and thus simplifies the outlet system and allows mounting by hand without the use of tools.

It will be understood that the attachment mechanism, i.e. the aperture 100 (FIG. 1), clip 110 (FIG. 2), and fastener 120 (FIG. 3) for example, can be arranged at different locations or comprise different attachment devices as needed for a particular electrical outlet. For example, the outlet cover 1 may include an attachment mechanism to frictionally engage the outlet 210, the box 140, or the recess 230 in the wall 130 for mounting the outlet cover 1 to the electrical outlet 210.

As described, the outlet cover 1 presents a substantially continuous front face 20, except for openings 90 and the optional aperture 100. Moreover, the openings 90 are closely matched to the size, shape, number and arrangement of contact openings 170 in an associated outlet 210 to be covered by the outlet cover 1. Accordingly, the outlet cover 1 substantially covers the entire outlet 210, including the receptacles 150, except for the contact openings 170 so that the contact openings 170 can be engaged by prongs 180 of an electrical plug 190.

In accordance with the present subject matter, the size, shape, number and arrangement of openings 90 in the outlet cover 1 are closely associated that of the contact openings 170, such that the openings 90 are aligned with the contact openings 170 when the outlet cover 1 is properly arranged relative to the outlet 210, such that prongs 180 of an associated plug 190 can pass through the openings 90 and electrically engage the contact openings 170 of the outlet 210 to provide power to an electrical device associated with the plug 190.

With reference to FIG. 4, and in accordance with the present subject matter, the size of the openings 90 are the same, or only slight larger than the size of the contact openings 170, and are arranged on the outlet cover 1 so that they align with the contact openings 170 as depicted, when the outlet cover 1 is properly arranged relative to the electrical outlet 210.

The relative size of the openings 90 and the contact openings 170 may be determined by comparing their area (e.g. W₁×H₁ vs. W₂×H₂, wherein W₁ is the width and H₁ is the height of a contact opening 170, and W₂ is the width and H₂ is the height of an opening 90), or by comparing their dimensions (e.g. W₁ vs. W₂, or H₁ vs. H₂). In one embodiment, an opening 90 in the outlet cover 1 has an area that is 1-2.5, 1-2, 1-1.5, 1-1.2, 1-1.1, or 1-1.01 times the area of the corresponding contact opening 170 in the electrical outlet 210 to be covered. In another embodiment, an opening 90 is 0 mm to 5 mm larger than the corresponding contact opening 170, as measured from the perimeter of the contact opening 170 along a line (e.g. L₁ or L₂) extending from the center (C) of the contact opening 170 and perpendicular to the perimeter of the contact opening 170. This is depicted in FIG. 4, wherein the size of the opening 90 is larger by a difference between W₂ and W₁, and between H₂ and H₁ (e.g. W₂−W₁=0 mm to 5 mm and H₂−H₁=0 mm to 5 mm). In still another embodiment, the openings 90 are smaller than the contact openings 170.

Accordingly, when the outlet cover 1 is properly arranged over the electrical outlet 210, the receptacles 150 and the remainder of the outlet 210, except for the contact openings 170, are covered and therefore not visible when viewed from the front face 20 side of the outlet cover 1. This allows the outlet cover 1 to hide the color or the outlet 210 and/or receptacles 150. In one embodiment, the outlet cover 1 is larger than the electrical outlet 210 such that it is capable of covering the electrical box 140 and wall recess 230, wherein the electrical box 140 and recess 230 are also not visible when viewed from the front face 20 side of the outlet cover 1 when the outlet cover 1 is properly arranged over the electrical outlet 210.

In an embodiment, the electrical outlet 210 (except for of the contact openings 170), the box 140, and the wall recess 230 are all covered by the outlet cover 1 and are not visible when the outlet cover 1 is properly arranged over the outlet 210 such that the openings 90 are aligned with the contact openings 170 as depicted in FIG. 4 for example, and when viewed from the front face 20 side of the outlet cover. As such, the color scheme or appearance of the outlet system 200 may solely depend on the color (or lack thereof) or appearance of the outlet cover 1. Because the receptacles 150 are not visible when the outlet cover 1 is properly arranged to cover the outlet 210, the color of the receptacles 150 cannot be seen when viewed from the front face 20 side of the outlet cover, and therefore the color of the receptacles 150 does not influence the color scheme or appearance of the outlet system 200. In one embodiment, only the contact openings 170 of the electrical outlet 210 are visible when the electrical outlet 210 is covered by the outlet cover 1, and the remainder of the electrical outlet 210 is not visible. However, as is conventional, the contact openings 170 are sized to accept the prongs 180 and are therefore relatively small compared to the receptacles 150, and the contact openings 170 are recesses in the receptacles 150 and therefore relatively dark. Accordingly, a color of the contact openings 170 is not visible from the front side of the outlet cover 1.

Accordingly, the color scheme or appearance of the outlet system 200 can be altered from the color of the receptacles 150, and from the color of an original wall plate—which has one or more conventional openings that are sized to correspond to the receptacles 150 and that allow the receptacles 150 of the outlet 210 to protrude therethrough—by simply replacing the original wall plate with the outlet cover 1 as disclosed herein. Such use of the outlet cover 1 results in substantial obscuring of the receptacles 150 from view, and allows for the appearance or color of the outlet system 200 to be easily changed without requiring changing of the electrical outlet 210 for one of a different color or appearance.

The material from which the outlet cover 1 is made is not particularly limited by the present subject matter, and the outlet cover can be formed from material include polymers (e.g. vinyl), metal, wood, ceramic, clay, stone, composite material, glass, and combinations and mixtures thereof for example. The outlet cover 1 can be formed by additive or subtractive manufacturing, including for example by casting, 3D printing, injection molding, or other means.

The size and shape of the outlet cover 1 is not particularly limited by the present subject matter, and the outlet cover 1 can include a face plate 10 having a rectangular (FIGS. 1-3), square, circular, and other shapes, and combinations thereof for example. Moreover, the front face 20 can be contoured, textured, flat, planar, or smooth. The outlet cover can have any color, texture, appearance, design, pattern, indicia, picture, photograph, or other aesthetic appearance, or combinations thereof as desired, including having an opaque, transparent, illuminated, translucent, or reflective appearance, or combinations thereof for example.

The thickness of the face plate 10 and other portions of the outlet cover 1 are not particularly limited by the present subject matter. In one embodiment, the face plate 10 is from 0.1 mm to 10 mm. In certain embodiment where the face plate 10 is relatively thin (e.g. 0.1 mm to 2 mm). This thin face plate 10 allows the receptacles to be covered, yet does not substantially interfere with the prongs 180 contacting the contact openings 170 to establish an electrical connection between the two. In one aspect, the back face 30 of the face plate 10 contacts the front face of the receptacles 150.

The outlet cover 1 can include one or more ribs 111 arranged on (e.g. integral with) the back face 30 of the face plate 10. The ribs 111 are configured to structurally support the face plate 10 and/or the attachment mechanism, i.e. the aperture 100 (FIG. 1), clip 110 (FIG. 2), and fastener 120 (FIG. 3) for example. As shown in FIG. 2, the ribs 111 are structurally supporting the clip 110 to provide rigidity to the clip 110 so that it can adequately support the outlet cover 1 when it is attached to an associated electrical outlet 210.

In several embodiments, the outlet cover is one integral piece, for example a one-piece injection molded plastic body. In another embodiment, the outlet cover is free of movable or swingable pieces or parts, such as a door, cover, or sliding mechanism that movably covers the contact openings 170 of an electrical outlet 210. In one aspect, when the outlet cover 1 is arranged over the associated electrical outlet 210 and the openings 90 are aligned with the contact openings 170 of the associated electrical outlet 210, only the contact openings 170 of the associate electrical outlet 210 can be seen from the front of the outlet cover 1 since the outlet cover 1 does not cover the contact openings 170. In other words, the openings 90 in the outlet cover 1 are aligned with the contact openings 170 of in the associated outlet 210. In another embodiment, the outlet cover 1 does not include electrical extensions for bridging an electrical gap between the contact openings 170 of an associated electrical outlet 210 and the prongs 180 on an electrical plug 190. Instead, the openings 90 of the outlet cover 1 allows the prongs 180 of the electrical plug 190 to pass therethrough in order to make contact with the contact openings 170 of the electrical outlet 210 for the transfer of electrical power from the electrified contact openings 170 to the prongs 180. In other words, the prongs 180 are inserted directly into the contact openings 170.

Many other benefits will no doubt become apparent from future application and development of this technology.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scopes of the claimed subject matter, as expressed in the appended claims.

What is claimed is:

1. An outlet cover configured to cover an associated electrical outlet, the outlet cover comprising:
a plate including a front face and an oppositely directed back face, and
openings extending through a thickness of the plate from the front face to the back face,
wherein the front face is substantially continuous except for the openings, and wherein the openings correspond in size, shape, and location to contact openings in the associated electrical outlet such that, when the outlet cover is arranged relative to the associated electrical outlet to cover the associated electrical outlet, a receptacle of the associated electrical outlet is covered by the outlet cover and the contact openings are not covered by the outlet cover.

2. The outlet cover according to claim 1, wherein when the outlet cover is arranged relative to the associated electrical outlet to cover the associated electrical outlet, the receptacle of the associated electrical outlet cannot be seen from a front side of the outlet cover.

3. The outlet cover according to claim 1, wherein when the outlet cover is arranged relative to the associated electrical outlet to cover the associated electrical outlet, the openings allow the contact openings to be engaged by prongs of an associated electrical plug.

4. The outlet cover according to claim 1, further comprising an aperture extending through the thickness of the plate from the front face to the back face, wherein:
the front face is substantially continuous except for the openings and the aperture, and
the aperture is configured to allow a connector to pass through the plate and engage a female threaded opening in the associated electrical outlet to secure the outlet cover relative to the associated electrical outlet.

5. The outlet cover according to claim 1, further comprising a connector configured to secure the outlet cover relative to the associated electrical outlet.

6. The outlet cover according to claim 5, wherein:
the connector comprises a clip arranged on the back face of the plate, and
the clip is configured to frictionally engage a head of a screw that is engaged to a female threaded opening in the associated electrical outlet in order to secure the outlet cover relative to the associated electrical outlet.

7. The outlet cover according to claim 5, wherein:
the connector comprises a rivet including fins extending out from the rivet,
the rivet is arranged on the back face of the plate, and
the rivet is configured to frictionally engage a female threaded opening in the associated electrical outlet to secure the outlet cover relative to the associated electrical outlet.

8. The outlet cover according to claim 1, wherein the outlet cover is a one-piece body.

9. The outlet cover according to claim 1, wherein the outlet cover does not include moving pieces or parts.

10. The outlet cover according to claim 1, wherein the outlet cover does not include electrical extensions configured to electrically bridge a gap between the contact openings and a prongs on an associated electrical plug.

11. An outlet cover configured to cover an associated electrical outlet, the outlet cover comprising:
a plate including a front face and an oppositely directed back face, and
openings extending through a thickness of the plate from the front face to the back face,
wherein when the outlet cover is arranged over the associated electrical outlet and the openings are aligned with contact openings of the associated electrical outlet, only the contact openings of the associated electrical outlet are visible from the front of the outlet cover.

12. The outlet cover according to claim 11, wherein the number of openings is the same as the number of contact openings of the associated electrical outlet.

13. The outlet cover according to claim 12, wherein the plate consists essentially of six openings.

14. The outlet cover according to claim 13, wherein:
the six openings comprise two sets of three openings, and
the two sets of three openings each include two generally rectangular openings and one generally semicircular opening.

15. The outlet cover according to claim 14, wherein each of the openings is 0 mm to 5 mm larger than a corresponding contact opening to which it is aligned as measured from a perimeter of the corresponding contact opening along a line extending from a center of the corresponding contact opening and perpendicular to the perimeter of the corresponding contact opening.

16. The outlet cover according to claim 11, further comprising side walls extending back from the plate, wherein the side walls and plate collectively define a hollow at a back side of the outlet cover.

17. The outlet cover according to claim 11, further comprising an aperture extending through the thickness of the plate from the front face to the back face, wherein:
the front face is substantially continuous except for the openings and the aperture, and
the aperture is configured to allow a connector to pass through the plate and engage a female threaded opening in the associated electrical outlet to secure the outlet cover relative to the associated electrical outlet.

18. The outlet cover according to claim 11, further comprising a connector configured to secure the outlet cover relative to the associated electrical outlet.

19. The outlet cover according to claim 18, wherein:
the connector comprises a clip arranged on the back face of the plate, and
the clip is configured to frictionally engage a head of a screw that is engaged to a female threaded opening in the associated electrical outlet in order to secure the outlet cover relative to the associated electrical outlet.

20. The outlet cover according to claim 19, further comprising:
one or more side walls extending back from the perimeter of the plate, and
a rib arranged on the back face of the plate and extending between a side wall and the clip and configured to structurally support the plate and the clip.
